(19) United States
(12) Patent Application Publication
(10) Pub. No.: US 2025/0141901 A1
(43) Pub. Date: May 1, 2025

(54) WEB APPLICATION AND APPLICATION PROGRAMMING INTERFACE (API) PROTECTION

(71) Applicant: Radware Ltd., Tel Aviv (IL)

(72) Inventors: Amnon LOTEM, Ramot Hashavim (IL); David AVIV, Tel Aviv (IL); Doron SHAVIT, Tel Aviv (IL); Orly Stan BENCHETRIT, Ramat Gan (IL)

(73) Assignee: Radware Ltd., Tel Aviv (IL)

(21) Appl. No.: 19/003,837

(22) Filed: Dec. 27, 2024

Related U.S. Application Data
(63) Continuation-in-part of application No. 17/831,889, filed on Jun. 3, 2022.

(51) Int. Cl. H04L 9/40

(52) U.S. Cl. CPC H04L 63/1425; H04L 63/1416

(57) ABSTRACT

Apparatus for filtering transactions transmitted from a source to a protected entity, comprising: a transaction filter enforcer which receives a layer 7 transaction destined for a protected application prior to the transaction possibly being supplied to the protected entity; and an evaluator receiving the transaction from the enforcer; the enforcer routing the transaction to the protected entity when the transaction does not receive a determination as being malicious from the evaluator; the evaluator including at least a model that determines a score indicative of the maliciousness of the transaction based on input from at least one trained model, the transaction being supplied to each of the at least one trained model, each of which is a model from a set of model types, the model types including an anomaly model and an attack model; the enforcer operating in real-time and the evaluator operating in at least near real-time.

### CROSS REFERENCE TO RELATED APPLICATIONS

This application is a continuation-in-part of U.S. patent application Ser. No. 17/831,889 filed on Jun. 3, 2022, the contents of which are incorporated herein by reference.

### TECHNICAL FIELD

This invention relates to cybersecurity, and more specifically, to detection of web application and application programming interface (API)-based attacks.

### BACKGROUND OF THE INVENTION

Web applications, which are programs that are accessible to users via a web browser, are advantageous for a number of reasons, among them that they provide to users the ability to use the applications without requiring downloading special software, libraries, plugins, and so on. Web applications, however, are vulnerable to web-based threats, such as the sending of malicious content to the application, and as such, web applications require security solutions. Similarly, an application programming interface (API) attack is a set of actions intended to exploit or misuse an API, e.g., with the goal of compromising data security or disrupting a business. One type of attack applicable to both web applications and APIs is an injection attack in which an attacker supplies malicious data to the API in the hope of inducing the application to behave in a manner not intended by its creator. For instance, in a Structured Query Language (SQL) injection attack, malicious SQL code is introduced to input fields so as to potentially expose, alter, or delete database contents.

To be protected, companies heavily invest in security solutions, such as anti-malware software and firewalls. However, as security solutions become more advanced, so do web attacks. Web attacks may be in the form of viruses, worms, Trojan horses, script-based, system intrusions, and many others. Such attacks allow the attacker to control computers, access confidential information, and destroy valuable data.

One such solution is a web application and API protection (WAAP). A WAAP is typically deployed in-line of traffic between clients and a server hosting a protected web-application, although it may also be implemented remotely, e.g., in the cloud, by first routing traffic to the WAAP prior to it possibly being supplied to the web application. A WAAP monitors and filters, e.g., blocks, some of the hypertext transfer protocol (HTTP) or hypertext transfer protocol secure (HTTPS) traffic that is communicated to and from a web application. This is achieved by supplying the WAAP with authorization rules or security policies to determine what traffic should be passed through and what traffic should be blocked. The security policies are configured based on known attack patterns or vulnerable application-paths. Such policies may be defined using a blacklist, which indicates what traffic should be blocked, or using a whitelist, which indicates what traffic is allowed to be passed through.

Prior art solutions typically manually configure WAAP policies. However, such an approach is inefficient, as it requires advanced knowledge of known attack patterns or paths. Configuring a WAAP for controlling access to an application can be a time-consuming process and is prone to human error. Furthermore, requirements are not static and so may fluctuate. This may lead to outdated, flawed, and therefore even dangerous misconfigurations of the WAAP. Additionally, some of the required values for configuration of the WAAP are not obvious, which complicates both its initial configuration and any reconfiguration of the WAAP that may be required. This complexity affects not only the time required for configuration of the WAAP, but the quality of such a configuration as well. Moreover, a deep understanding of each specific application is required to properly configure a WAAP, which means in turn that highly professional personnel are necessary, which are both hard to find and expensive.

Furthermore, as web applications are dynamically changed by programmers and the system administrator, they often do not have full control over all of these rapidly occurring changes. Therefore, many of the changes are reported after they are made, if they reported at all. The entire process of fine-tuning the WAAP takes more time, and more resources, than a typical organization can practically invest. Thus, typically, the policy is statically enforced, and the web applications remain vulnerable.

Other solutions suggest crawling the web-applications to learn the structure of an application and generate policies based on the crawling. This is not a static solution yet such crawling cannot be rapidly performed to capture changes in a web application. In today's computing environment, applications may be changed every a few seconds, e.g., online retail sales applications.

In addition, attacks on all kinds of computer systems have been increasing, requiring various cybersecurity systems to provide protection. Some such attacks include SQL injection, which are directed to databases, and code injection, which is more general.

Presently available systems typically communicate via a series of transactions at Layer 7, i.e., the application layer, of the Open Systems Interconnection (OSI) model, e.g., the layer that uses Hypertext Transfer Protocol (HTTP) or Hypertext Transfer Protocol Secure (HTTPS), which is a secure version of HTTP. HTTP functions as a request-response protocol in the client-server model protocol in that for every request sent by a client, e.g., a web browser, the server responds with a response thereto. Transactions of the HTTP/HTTPS protocol may include GET, HEAD, POST, PUT, PATCH, DELETE, HEAD, CONNECT, OPTIONS, TRACE, and PATCH and each may include various arguments.

To provide security, prior art protection systems inspect each transaction individually at layer 7. As noted above, this may be done by a firewall, e.g., a WAAP, or other device located in-line with the server or application to be protected. Alternatively, again as noted above, it may be done remotely, e.g., in the cloud, e.g., implemented as software as a service (SaaS), where transactions prior to being processed by a server are routed to a remote protection system which inspects each transaction and, if it is determined that the transaction is not part of an attack, then the transaction is routed back to the server or application to be processed. These protection systems use rules to determine if a specific transaction matches a known attack. Such rules may be implemented as signatures. Thus, if there is a matching signature for a transaction, i.e., the transaction matches a rule, that transaction is considered to be part of an attack. Transactions that are determined to be part of an attack, i.e., malicious transactions, are blocked.

Disadvantageously, it is impractical to include a rule for every possible attack or vulnerability exploit. This is because of the extremely large number of vulnerabilities, which are believed to increase as time goes on, as well as the variations of the vulnerabilities. Furthermore, even an old vulnerability might not be fully covered by a rule. Moreover, these systems only work for known vulnerabilities or attacker techniques, i.e., vulnerabilities for which there is an already existing rule or signature. As such, they cannot protect against a zero-day attack, i.e., a new attack of first impression, and transactions of such attach will be passed on without being blocked.

### SUMMARY OF THE INVENTION

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include apparatus for filtering layer 7 transactions, each transaction being transmitted from a source to a protected entity. The apparatus comprises: computing circuitry implementing a transaction filter enforcer which at least receives a layer 7 transaction destined for a protected application prior to the transaction possibly being supplied to the protected entity; and computing circuitry implementing an evaluator, the evaluator receiving the transaction from the enforcer; wherein the enforcer routes the transaction to the protected entity when the transaction does not receive a malicious determination from the evaluator for the transaction; and wherein the evaluator includes at least a scoring model that determines a score indicative of whether the transaction is malicious or non-malicious based on input from at least one trained model, the transaction being supplied to each of the at least one trained model, each of the at least one trained model being a model from a set of available model types, the available model types being an anomaly model, and an attack model; wherein the enforcer operates in real-time and the evaluator operates in at least near real-time.

Certain embodiments disclosed herein includes a method for filtering layer 7 transactions, each transaction being transmitted from a source to a protected entity. The method comprises: receiving, at an enforcer, a layer 7 transaction destined for a protected application prior to the transaction possibly being supplied to the protected entity; and supplying the transaction, by the enforcer, to an evaluator, wherein the evaluator includes at least a scoring model that determines a score indicative of whether the transaction is malicious or non-malicious based on input from at least one trained model, the transaction being supplied within the evaluator to each of the at least one trained model, each of the at least one trained model being a model from a set of available model types, the available model types including at least an anomaly model and an attack model; and wherein the enforcer routes the transaction to the protected entity when the evaluator does not receive for the transaction a malicious determination from the evaluator; wherein the enforcer operates in real-time and the evaluator operates in at least near real-time.

### BRIEF DESCRIPTION OF THE DRAWING

### In the Drawing:

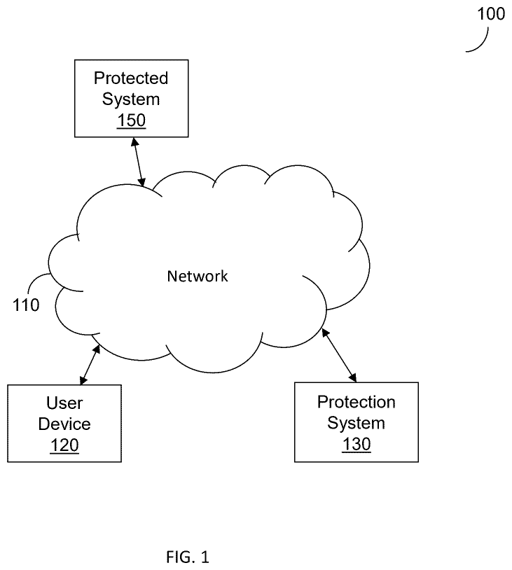

FIG. 1 shows an illustrative arrangement for describing various disclosed embodiments;

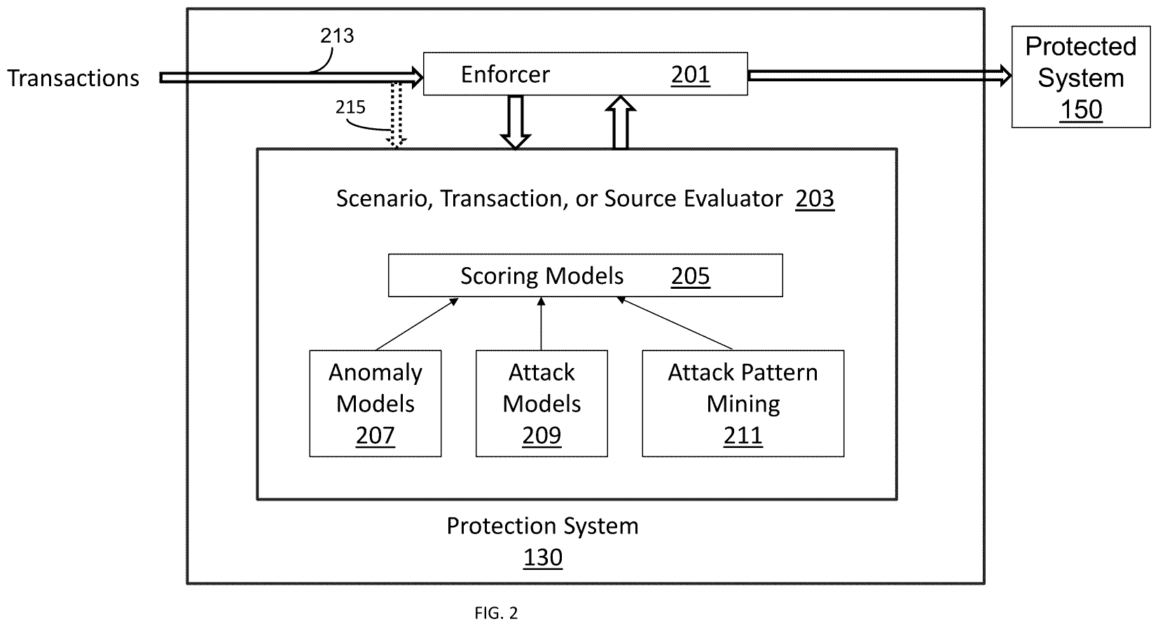

FIG. 2 shows a more detailed view of an illustrative arrangement for implementing the protection system of FIG. 1;

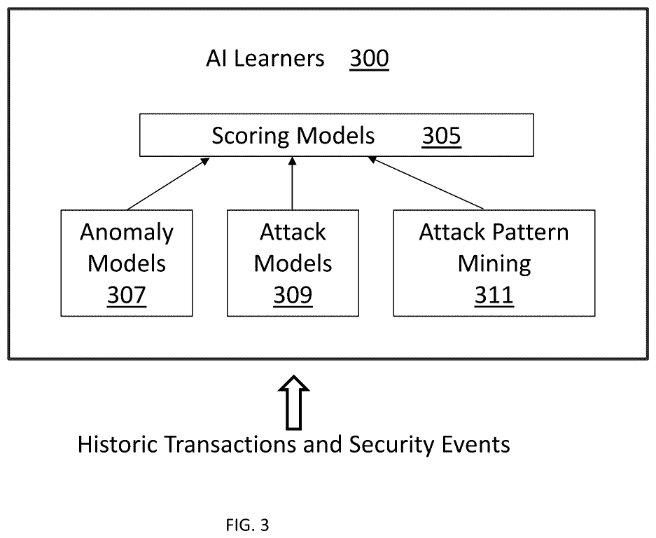

FIG. 3 shows an illustrative embodiment of the training of the various models ultimately employed in FIG. 2; and

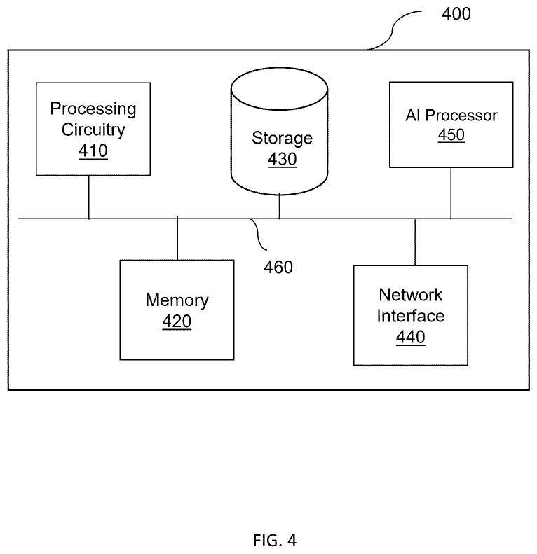

FIG. 4 shows an illustrative system that may be used to implement any of a user device, a protection system, or a protected system shown in FIG. 1.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

As noted above, prior-art cybersecurity systems only work for known vulnerabilities or attacker techniques, and, as such, they cannot protect against a zero-day attack. Further disadvantageously, they process each transaction separately, i.e., independently on its own. We have recognized that, in accordance with the principles of the disclosure, rather than simply analyzing transactions on their own that also a sequence of the transactions should be analyzed, i.e., the transactions should be analyzed wholistically. Thus, what is the behavior of a sequence of transactions is analyzed. In addition, the sequence of transactions may be looked at from different perspectives, e.g., using an anomaly models and attack models.

A sequence of transactions may also be referred to as a scenario. The length of the scenario could be limited based on some criterion, e.g., number of transaction or time, or the length may not be limited. When the length is not limited, the scenario may relate to all of the transactions that have arrived from a source to a present time. When a scenario length is limited, it could be viewed as being analogous to a moving window over the sequence of transactions from the source to the application, e.g., moving in some predefined steps, where the step size is the number of transactions to shift the window relative to the previous window.

More specifically, in accordance with the principles of the disclosure, a protection system for web applications and applications that expose an application programming interface (API) applications, i.e., a WAAP, may employ an artificial intelligence (AI) or machine learning approach to detect an attack at layer 7 and, advantageously, the protection system may combine more than one technique to determine if any transaction is part of an attack. To this end, in accordance with an aspect of the disclosure, at least two levels of detection and enforcement are employed. A first level looks at the sequence of transactions from a source to the same destination, e.g., a scenario, so that the sequence is looked at holistically, i.e., what is going on with the transactions as whole, so as to determine what is the behavior of the sequence of transactions. A second level looks at the sequence of transactions from different perspectives, and in particular, may look at each transaction individually.

A goal of doing so is to determine a score for a single transaction based on suspect indicators computed for the transaction. A high score of for a transaction result may result in blocking the transaction. Such could be done in real-time.

Also, as discussed further hereinbelow, a scenario may be assigned a score, e.g., based on suspect indicators computed for the scenario, and this may be done in near real-time. In addition, there may be developed a score for the source of the transactions of the scenario. Such a score could be determined based on the scores of the scenarios that originate from such source or based on the suspect indicators of its scenarios. For example, a high score of a source could mean that the source is malicious with high probability that the source is a “bad actor”, and therefore mitigation actions like blocking or challenging are performed.

The foregoing may be achieved by employing at least two models, an anomaly model and an attack model. Pattern mining may also be employed.

In an embodiment, the models are at least initially developed off-line, e.g., during a training phase. In some embodiments, the development of the models is ongoing during the operating phase, i.e., the models are updated over time based on what is actually being experienced.

An anomaly model learns normal behavior involving the resource, e.g., application, being protected. This may be during peacetime, i.e., when no attack or at most a limited number of attacks, is underway. Also, the anomaly model may be initially developed offline using a repository of recorded transactions that make up various scenarios. Characteristics of normal behavior are thus extracted as part of the analysis by the model as it is being developed. For example, as part of the learning, the anomaly model learns what are the characteristics of typical values for each query argument of the application. Learning for an anomaly model may be achieved using unsupervised leaning. For example, if an argument of a transaction usually has ten characters and suddenly it has 50 characters, regardless of what the characters are, this will be characterized as suspicious. Anomaly models are usually developed on a per-application basis.

To minimize noise in the learning process, malicious and suspicious transactions, or transactions from previously recognized malicious or suspicious sources, are ignored. That may be done by filtering out transactions or sources previously observed to be suspect. Noise filtering statistical methods may also be used.

During operation, the anomaly models are used to check if the transactions or scenarios received are in accordance with what was learned by the model. If not, the model produces suspect indicators. These indicators are then considered as the basis for scoring the source or for the transaction. The scoring may be further based on other types of indicators.

Building a model for detecting a transaction anomaly involves learning the typical characteristics of the transactions or the elements of the transactions employed by each protected application and storing that as a baseline. Elements of a transaction could be, for example, a query argument, a header, a cookie, a path parameter, a body parameter, and the like.

A characteristic of an application's transactions could relate to, for example, the set of known hosts, e.g., subdomains, of the application, known URL paths of the application, known query argument keys, known cookies, known headers, known body arguments, known methods, known file extensions of resources mentioned in the URLs, and the like. Transaction characteristics could be learned a) globally for the application, b) per URL path of the applications, e.g., query argument keys and body param keys, or c) both of the foregoing.

Thus, anomaly models can pertain to either or both the level of the transaction and the level of the scenario. Also note that transaction level anomalies may also be used at the scenario level, e.g., considering in how many of the transactions of the scenario an anomaly was detected.

Furthermore, value characteristics of, i.e., the nature of the values for, specific transaction elements may be learned by the model. Value characteristics are items such as 1) the number of characters in the value of a string, i.e., the string's length, 2) the set of characters typically found in the string, 3) the type of a value of an element, e.g., integer, real, string, time, enum of certain set of values, UUID, base64, and the like, and 4) the format of the string of the value, e.g., regular expression that describes it.

Value characteristic of a transaction element could be learned by the model a) globally for the application, e.g., query argument keys, body param keys, and header keys without the context of the URL path, or b) per URL path of the applications, e.g., query argument keys and body param keys with the context of the URL path, or c) both. For example, the model may learn that in application X there is a URL path “/app1/v3/login” which has a query argument called “name”, where the value type of the query argument “name” is string and the string has a length that is not greater than 20 characters. Or more globally: the model may learn that in application X there are query argument called “name” where the value type of the query argument “name” in any URL of the application is string and the string has a length that is not greater than 20 characters.

During the operating phase, when the model encounters an unknown key, i.e., a key that was not learned by the model in the learning period or encounters a known key but with a value which does not comply to the value characteristics, such as length, type, or format of the value that has been learned, a suspicious indicator is raised.

Repeating occurrences of such indicators in transactions during the scenario, i.e., as part of the activity of the actor, increases their suspect level for those transactions and the scenario. For some indicators, a reliability threshold may be learned, i.e., how many occurrences of the suspect indicator should be observed in a scenario to decide that the suspect level is reliable enough.

Building a model for detecting a transaction anomaly requires the learning of the typical characteristics of a sequence of transactions, i.e., the transactions of a scenario, from a source to the application.

One category of anomaly models for scenarios is scenario metrics in which metrics, e.g., different counts and rates of transaction property occurrences, are computed to so that the model will know what are the typical or normal ranges of these metrics. In this category, the normal counts and rates of different properties of the transactions within each scenario of an application is learned. Counts are typically best used when the length of the scenario is fixed, e.g., 20 transactions, while rates are typically best used when scenarios of different length are considered.

The following are examples that can be learned for counts and rates of transaction properties of an application's scenarios by an anomaly model:
The count or rate of a certain method, e.g., POST, GET, PUT, DELETE, HEAD
The count or rate of a certain file extension, or a category of file extensions of a URL, e.g., .php.

Statistics of certain properties could also be learned by an anomaly model. For example:
The average, min, max and standard deviation of the number of headers in the scenario's transactions.
The average, min, max and standard deviation of the number of URL path segments in the scenario's transactions.
The average, min, max and standard deviation of the time difference between the scenario's transactions.
The max number of distinct values of a certain query argument or a path parameter in the scenario's transactions.
The max number of transactions with the same URL path in the scenario.

The distribution of the counts, rates or values, over large set of scenarios, enables computing anomaly thresholds to be set, such as:
Appearance of the POST method in more than 60% of the transactions, happens only in only 0.5% of the scenarios.
The average number of headers in a scenario is at least 5 in 99.5% of the scenarios.

During the operating phase, when evaluating a particular scenario, a count, a rate, or a value above or below a prescribed threshold value indicates the likelihood of there being an anomaly and triggers a suspect indicator.

Detection of an anomaly of a sequence may also be determined using methods that look for a multi-dimensional anomaly such as Isolation Forest. A group of counters, rates, and values computed for a scenario is represented as a vector of attributes. The anomaly of the vector in the multi-dimensional space is then determined.

Yet a further category of anomaly models for scenarios is based on the sequence and order characteristics of transactions within the scenario. More specifically, the order or relationships between the transactions of the scenario are learned by the model. Such learned properties are intended to represent the normal behavior of the application's scenarios. For example, one such relationship might relate to an ordering constraint, such as the communication of an actor with an application starts with a URL path from a list of learned URL paths in 98% of the scenarios.

Vector embedding may also be applied to a scenario's sequence of transactions so as to transform the sequence of URLs and related transaction elements into a vector of numbers. Vector embedding may be done, for example, by applying an artificial intelligence (AI) transformer to predict the next transaction in the sequence of transactions.

Once scenarios are represented using numeric vectors, during the operating phase, when evaluating a particular scenario, anomaly detection methods could be used to determine the anomaly score of a scenario.

An attack model learns what is common to an attacker. This is learned from at least one historic case, and the attack model generalizes behavior of attackers based on the data of the historic cases. Note that “historic” is not necessarily long ago but is just an earlier time period, e.g., it may simply be a few minutes earlier. Thus, an attack model learns the characteristics of attacks in general, e.g., probing, i.e., multiple attempts to access something, where each attempt at access may be in a different way, the pace of requests, e.g., whether they are quick or not, and so forth. The attack model is based on various scenarios, i.e., various sequences of transactions. The learning for an attack model may employ supervised learning so as to generalize attacker behaviors based on a large number of historic attacks from different attackers, e.g., web application attacks generally and, more specifically, attacks on web applications that expose an API. The supervised learning could be applied to generate transaction-level attack models or scenario-level attack models.

For transactions, a suspect indicator aims to raise some suspicion of a problem with the transaction, but it might not be reliable enough to act alone as a rule, or its complexity computation could be too high to be applied inline, such as requiring certain machine learning (ML) or AI models to identify malicious values in transaction fields.

The following are examples of transaction-level attack models:
An SQL injection model is based on large number of historic SQL strings, and a large number of benign strings, although some of them might include SQL-like terms that are used legitimately. Training examples could come from existing rule-based systems, threat intelligence, and generative AI methods for generating malicious and benign examples. A supervised ML model such as Random Forest or XGBoost are used for training the model.
A code injection model that is similar to the SQL injection model but based on code injection examples.
An XSS model which is similar to the SQL injection but based on XSS examples.

During the operating phase, these models are applied to relevant transaction fields and provide a score, e.g., probability, of the existence of an attack pattern within the transaction. The score is held in a suspect indicator, which is later in the process considered by the scoring model of the transaction or the scenario to determine the overall score. For the scenario level, the number of transactions or transaction fields that were categorized as attack strings or received high scores as attacks string could be used as the suspect indicator.

In addition to the above attack models, several simpler attack indicators can be computed for an individual transaction. Examples of such simpler attack indicators include:

An illegal or risky host, e.g. an IP address that is specified in the hostname
An illegal or risky path element, e.g. a path with various navigation signs, like . . . \ or . . . \)
An illegal or risky referrer

Such indicators may also be considered by the scoring model.

Scenario level suspect indicators are based on the behavior of a source rather than on any single transaction. Illustrative scenario level suspect indicators may include:
Repeated requests to non-existing resources or accessing resources in an improper way resulting in a bad status code, e.g., 4xx, 5xxx. Such an indicator may be based on the count or rate of these “bad” status code in a scenario within a scenario.

Probing behavior such as where the attacker tries the same or different attack actions on different contexts, e.g., URL paths or transaction fields. The suspect indicators might relate, for example, to the maximum number or rate of:
the same resource name, e.g., the file name withing the URL path appearing in different paths of the scenario
distinct values in the same field across the scenario, e.g., certain path parameters, query argument, header, or body parameter
The same value or pattern in different contexts, e.g., different headers, query arguments, path parameters and body parameters.

Note that the probed resource or value is not known in advance as this may be a completely new attack. It is the above behavior that makes the scenario suspicious. Thresholds for these counters or rates, might be learned based on a comparison of their value distribution in legitimate scenarios versus known attack scenarios, e.g., that are identified or labeled by other sources.

Another suspect indicator could be created by a supervised ML model. Such a ML model might use for its features counters, rates, and ratios of different transaction properties in the scenario. It could produce a Boolean classification, i.e., malicious or legitimate or a score, e.g., representing a probability, of being malicious.

An additional ML model could be based on a vector embedding representation of the scenarios. The supervised ML models are typically trained using algorithms like Random Forest and XGBoost on a set of historic attack and legitimate scenarios. The attack scenarios could be scenarios that were detected as such by other systems, for example, prior art rule-based systems or based on some combination of indicators.

Attack models and attack pattern mining are general to all applications.

An additional technique, pattern mining, may be employed to find attack patterns. More specifically, pattern mining is employed to look for patterns in the transactions. One type of pattern mining identifies somewhat suspicious patterns that repeatedly appear in multiple contexts of the scenario transactions. See, for example, U.S. patent application Ser. No. 17/831,889 filed on Jun. 3, 2022, the contents of which are incorporated herein by reference. Another type of pattern mining is focused on crowd sourcing. Such crowdsourcing may be done at learning time, which may be at an offline time or on-going but not necessarily during detection time. During such process somewhat suspicious strings, e, g., as described hereinbelow, may be forwarded to a central location or repository so that they could be analyzed together in order to identify unknown attack patterns that are seen to be common, e.g., they repeat across applications and/or over time. Patterns given a high score, e.g., due to frequent repetition, which may be determined using repetition counters, are used to find new transactions that match one of the string patterns, and raise an indication of suspicion for the transaction and its scenario For example, if characters are used in the string of a request to an application and these characters are not common to requests for other applications, then such a request may be considered suspect of being malicious.

Attack pattern mining is a method for the discovery of unknown malicious string patterns. These malicious strings could relate to a completely new, i.e., a zero-day, vulnerability exploit or another unknown or not previously modeled attack technique. The pattern mining is based on encountering the appearance of a somewhat suspicious string in multiple contexts. A string could be considered as somewhat suspicious because of, for example:
Inclusion of risky characters, e.g., the appearance of different special characters typical to attackers. This may be matched with further criteria such as a low entropy or entropy ratio of the set of characters in the string.
Some anomaly relative to the typical characteristics of a transaction field, e.g., a query argument that is expected to include an integer number but includes a string with characters that are not digits, e.g., as in the transaction anomaly description above.

One type of attack pattern mining is based on the scenario scope. The mining process tries to find a somewhat suspicious string that appears in multiple contexts in the scenario's transactions. e.g., in different query arguments, header fields, and body parameters. To this end, a local per-scenario memory may be maintained to record the somewhat suspicious transactions and to identify the multiple occurrences of them that appear in different contexts. The strings might be recorded as is or passed through vector embedding. The vector embedding representation enables identification of multiple occurrences of similar strings, e.g., using semantic similarity techniques.

A pattern mining suspect indicator is raised for the scenario when such a string is detected. Indicators of that type are considered, e.g., along with other types of suspect indicators, to determine the score of the scenario.

Another type of attack pattern mining is based on crowdsourcing. The mining process attempts to find a somewhat suspicious string that appears across a significant number of applications, but it does not match to any known attack patterns, i.e., it is potentially a new pattern. In some embodiments, to implement such a process the somewhat suspicious strings of the different applications have to be forwarded, which may be more or less continuously or periodically, to a central location or repository. There the strings are aggregated based on identity or similarity, and counts are computed for the aggregations. e.g., number of occurrences, number of applications, number of customers, number of distinct contexts, and time span, e.g., number of days. To determine similarity the strings might be passed through vector embedding. The vector embedding representation enables aggregation of similar strings, e.g., using semantic similarity techniques. An aggregation of similar strings could be represented using a string pattern, e.g., a regular expression which corresponds to all or most of the string instances it aggregated.

Scoring and decision criteria are applied for the string aggregations, based on the counters, to identify those string aggregations which can be considered as malicious or highly suspicious. The string patterns of the malicious or suspicious enough string aggregations, are used by the evaluator to find new transactions that match one of the string patterns, and raise a suspect indicator for the transaction and its scenario. If the suspect indicator is strong enough, e.g., based on the score of the string pattern, it could cause on its own a requirement of mitigation for the transaction or the scenario. If not, the suspect indicator is considered, e.g., by the scoring model, along with other types of suspect indicators to determine the score of the transaction or the scenario.

As indicated above, each model, when it finds something, which may be a request or sequence of requests, that is suspicious, creates a suspect indicator for that thing. The individual suspect indicators from each anomaly model and attack model are combined into a vector of suspect indicators and the vector is supplied to a scoring model as the basis for deciding if the thing found is malicious or benign, i.e., an attack or not an attack. The scoring model may be developed offline using machine learning, e.g., supervised, to develop during training an overall score done using labeled data. The scoring model may learn which suspect indicators are most important during the training done offline.

In an embodiment, a scoring model may determine the maliciousness score of a scenario, which may be based on the suspect indicators produced by one or more of the anomaly models, attack models, and the pattern mining for a scenario. Another scoring model can determine the maliciousness score of an individual transaction, based on the transaction-level suspect indicators produced by at least one of the anomaly models, attack models, and the pattern mining. In an embodiment, one or more of the scoring models are supervised machine learning models.

The models are typically supervised machine learning models. The scenario scoring model may be trained using training data sets made up of labeled scenarios, where each scenario is represented by a feature vector, i.e., the set of suspect indicators computed for it. Similarly, the transaction scoring model may be trained using training data sets of labeled transactions, where each transaction is represented by its feature vector, i.e., the set of suspect indicators computed for it. The labels for the sets may be derived from or based on various sources such as: other detection systems, e.g., prior art rule-based systems, manual labels developed by domain experts, or generative AI techniques that were trained by domain experts.

The scenario scoring model used for an application could be a global model that is used for all the applications, or a more local one that is trained for individual applications or based on a subset of somewhat similar applications. The foregoing is also applicable for the transaction scoring model.

A simpler alternative to a supervised learning model, such as a heuristic score, e.g., a weighted sum of the feature vector, may be employed in some embodiments.

The scoring of a source could be done on a continuing basis by aggregating scores or suspect indicators of scenarios associated with the source. Note that because a scenario is typically limited by number of transactions or time, multiple scenarios might be associated with a source. Aggregating the scores of multiple scenarios might be done by taking, for example, the maximal score for the scenarios that have been developed so far.

During the operating phase, transactions are routed to an evaluator. The evaluator employs one or more of the various models, which, after being built during offline training, are pushed thereto, to evaluate whether the source of a transaction or the transaction itself is malicious based on its maliciousness score. Thus, the evaluator includes trained versions of the models which it uses to develop the maliciousness score. In an embodiment, the evaluator, at least initially, may operate in near real-time.

In an embodiment, an enforcer, to which each transaction must be routed before it can possibly be transmitted to the protected entity, supplies such transactions to the evaluator. This embodiment is important to implement real-time protection

In an embodiment, the evaluator may receive transactions that are not supplied to the enforcer. Instead, these transactions are sent directly to the evaluator. For example, such transactions may originate from the mirroring of transactions at network level, where a copy of a transaction is created by a network device which then sends the copy to the evaluator for evaluation. The evaluator performs the evaluation of the transaction it receives, e.g., in the same manner as if the transaction was supplied to it from the enforcer. If the evaluator determines that the source of any transaction so supplied is malicious, it will inform the enforcer, which can mitigate future transactions originating from that source.

During the operating phase, a mitigation action may be performed, e.g., by the enforcer, with respect to transactions or to a source that are found to be malicious. For example, one or more of the transactions may be cleaned or dropped, i.e., not forwarded to the entity to which it was initially being transmitted. As another example, a source may be blocked entirely so that none of its further transactions are forwarded to the entity to which it was initially being transmitted. Another example of a mitigation action is challenging the source of the transactions to determine if it is legitimate. The mitigation action may be implemented by what is referred to herein as an enforcer, to which transactions from various sources are directed before they may be sent back to the protected entity. The enforcer may implement mitigation decisions determined by the evaluator or it may take action based on scores it receives from the evaluator look. In an embodiment, the enforcer may operate in real-time.

Unlike the prior art, advantageously, in accordance with the disclosure, matching with respect to signatures, is not performed and hence no signatures are required.

Although initially, in some embodiments, because sequences are being looked at rather than only individual transactions, the operation may be only in near real-time, since the sequences must be observed over time. However, in some embodiments, if there are enough indicators in a transaction to determine that it is malicious, such can be blocked in real time.

FIG. 1 shows an illustrative arrangement 100 for describing various disclosed embodiments. The illustrative arrangement of FIG. 1 includes user device 120, protection system 130, and a system to be protected, i.e., protected system 150, which are communicatively connected via a network 110. Network 110 may be, but is not limited to, a wireless, cellular or wired network, a local area network (LAN), a wide area network (WAN), a metro area network (MAN), the Internet, the worldwide web (WWW), similar networks, and any combination thereof.

User device (UD) 120 may be, but is not limited to, a personal computer, a laptop, a tablet computer, a smartphone, a wearable computing device, or any other device capable of communicating with protected system 150. User device 120 may be a legitimate user, an attacker, or an attack tool.

User device 120 transmits transactions to protected system 150, which is the protected entity. Protected system 150 may be simply a web application or API within a computing device. All transactions sent to protected system 150 must, before being processed by protected system 150, be sent to protection system 130, which evaluates the transaction, along with possible any sequence to which it belongs, to determine if the transaction is legitimate or malicious. If the transaction is legitimate, it is routed to protected system 150 to be processed. If the transaction is not legitimate, either on its own or due to the source from which the transaction originated, a mitigation operation such as described hereinabove is performed on it, e.g., it is blocked and so it is not sent to protected system 150 to be processed.

Any of user device 120, protection system 130, or protected system 150 may be implemented as virtual machines. Similarly, any of user device 120, protection system 130, or protected system 150 may be implemented in the cloud. Also, although only one of each of user device 120, protection system 130, and protected system 150 are shown, this is for pedagogical purposes only. In practice, more than one of each may be deployed.

FIG. 2 shows a more detailed view of an illustrative arrangement for implementing protection system 130. Shown in FIG. 2 are enforcer 201, scenario, transaction, or source evaluator 203, scoring models 205, anomaly models 207, attack models 209, and attack pattern mining 211.

In an embodiment, indicated by the complete solid arrow 213 extending from “transactions” to enforcer 201, each transaction from user device 120 is routed to enforcer 201 before it can possibly be transmitted to the protected entity. Enforcer 201 supplies each transaction to source or transaction evaluator 203. The scenario, transaction, or source evaluator 203 employs one or more of the various model types, e.g., anomaly models 207, attack models 209, and attack pattern mining 211, which, after being initially built during offline training, are pushed to scenario, transaction, or source evaluator 203, for its use in evaluating whether the scenario of which the transaction is a part, the transaction itself, or the source of the transaction itself is malicious, i.e., not legitimate, based on a maliciousness score, as described hereinabove. More specifically, the scoring models 205 employ suspect indicators developed by the anomaly models 207, attack models 209, and attack pattern mining to develop the maliciousness score.

Transactions determined to likely not be malicious, e.g., by having a maliciousness score below a specified threshold, are passed by enforcer 201 to protected system 150. Transactions determined to likely to be malicious, e.g., by having a maliciousness score above a specified threshold, have a mitigation action performed thereon by enforcer 201. Such mitigation action may include, for example, cleaning or dropping the transaction.

In one embodiment, scenario, transaction, or source evaluator 203 returns to enforcer 201 a maliciousness score, upon which enforcer 201 makes a decision as to whether or not to perform a mitigation action or to pass the transaction on protected system 150. In another embodiment, scenario, transaction, or source evaluator 203 returns to enforcer 201 a decision as to whether or not to perform a mitigation action or to pass the transaction on protected system 150 based on the maliciousness score that it developed. In order to ensure that transactions are timely processed on behalf of the originator of the transaction, e.g., preferably a user device although, unfortunately, it may be instead an attacker, enforcer 201 may wait a prescribed amount of time for an answer from scenario, transaction, or source evaluator 203. In the event a maliciousness score or decision is not provided by enforcer 201 to scenario, transaction, or source evaluator 203 by the end of the prescribed amount of time, so that whether or not a mitigation action should be performed cannot be determined by the end of the prescribed amount of time, the transaction is passed on to protected system 150. However, scenario, transaction, or source evaluator 203 will nevertheless continue its evaluation and whatever score it determines will be recorded. The determined score will be used as part of the processing for the next transaction.

In an embodiment, if scenario, transaction, or source evaluator 203 determines that a source is malicious, it may so inform enforcer 201 so that enforcer 201 can drop any transactions originating from that source in the future, e.g., in real-time.

In an embodiment, indicated by dotted arrow 215 which is fed from solid arrow 213 to indicate transactions that do not go to enforcer 201 but instead are supplied directly to scenario, transaction, or source evaluator 203. For example, as noted above, such transactions may originate from the mirroring of transactions at network level, where a copy of a transaction is created by a network device which then sends the copy to scenario, transaction, or source evaluator 203 for evaluation. Scenario, transaction, or source evaluator 203 performs the evaluation of the transaction it receives, e.g., in the same manner as if the transaction was supplied to it from enforcer 201. If scenario, transaction, or source evaluator 203 determines that the source of any transaction so supplied is malicious, it will so inform the enforcer 201, which can mitigate future transactions originating from that source.

FIG. 3 shows an illustrative embodiment 300 of the training of the various models ultimately employed in FIG. 2. The models, although having the same names as the models of FIG. 2 have been given different reference numerals in FIG. 3 because they are not yet fully trained and supplied to scenario, transaction, or source evaluator 203. Transactions and security events which may be historic transactions and events are employed to train anomaly models 307, attack models 309, and attack pattern mining 311 along with scoring models 305 in the manner described hereinabove. Security events are events that are reported by other web application firewall (WAF) protection systems, such as rule-based systems. They can be used as part of the evaluation to mark scenarios and sources as probably malicious. Such marking may be used to filter-out attack scenarios in learning the normal behavior of an application or as an initial label for a supervised learning model.

FIG. 4 shows an illustrative system 400 according to an embodiment. The arrangement and structure of system 400 may be used to implement any of user device 120, protection system 130, or protected system 150.

System 400 includes a processing circuitry 410 coupled to a memory 420, a storage 430, a network interface 440, and an optional artificial intelligence (AI) processor 450. In an embodiment, the components of the system 400 may be communicatively connected via a bus 460.

The processing circuitry 410 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 420 may be volatile, e.g., random access memory, etc., non-volatile, e.g., read only memory, flash memory, etc., or a combination thereof.

In one configuration, software for implementing one or more embodiments disclosed herein may be stored in the storage 430. In another configuration, the memory 420 is configured to store such software. Software shall be construed broadly to mean any type of instructions, whether referred to as software, firmware, middleware, microcode, hardware description language, or otherwise. Instructions may include code, e.g., in source code format, binary code format, executable code format, or any other suitable format of code. The instructions, when executed by the processing circuitry 410, cause the processing circuitry 410 to perform the various processes described herein.

The storage 430 may be magnetic storage, optical storage, and the like, and may be realized, for example, as flash memory or other memory technology, compact disk-read only memory (CD-ROM), (DVDs), or any other medium which can be used to store the desired information.

The network interface 440 allows the system 400 to communicate with other devices, e.g., of FIG. 1, over network 110.

In some configurations, the system 400 may further include an artificial intelligence (AI) processor 450. The AI processor 450 may be realized as one or more hardware logic components and circuits, including graphics processing units (GPUs), tensor processing units (TPUs), neural processing units, vision processing units (VPU), reconfigurable field-programmable gate arrays (FPGA), and the like. The AI processor 450 is configured to perform, for example, machine learning based on XXX received from the I/O interface 440.

It should be understood that the embodiments described herein are not limited to the specific architecture illustrated in FIG. 4, and other architectures may be equally used without departing from the scope of the disclosed embodiments.

The various embodiments disclosed herein can be implemented as hardware, firmware, firmware executing on hardware, software, software executing on hardware, or any combination thereof. Moreover, the software is implemented tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (CPUs), a memory, and input/output interfaces. The computer platform may also include an operating system and microinstruction code. The various processes and functions described herein may be implemented as either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. Apparatus for filtering layer 7 transactions, each transaction being transmitted from a source to a protected entity, comprising:
computing circuitry implementing a transaction filter enforcer which at least receives a layer 7 transaction destined for a protected application prior to the transaction possibly being supplied to the protected entity; and
computing circuitry implementing an evaluator, the evaluator receiving the transaction from the enforcer;
wherein the enforcer routes the transaction to the protected entity when the transaction does not receive a malicious determination from the evaluator for the transaction; and
wherein the evaluator includes at least a scoring model that determines a score indicative of whether the transaction is malicious or non-malicious based on input from at least one trained model, the transaction being supplied to each of the at least one trained model, each of the at least one trained model being a model from a set of available model types, the available model types including at least an anomaly model and an attack model;
wherein the enforcer operates in real-time and the evaluator operates in at least near real-time.

2. The apparatus of claim 1, wherein the evaluator is further adapted to receive and evaluate at least one transaction from at least one source other than the enforcer.

3. The apparatus of claim 2, wherein the at least one transaction from the at least one source other than the enforcer are used as part of a determination as to whether a source of the at least one transaction from the at least one source other than the enforcer is malicious.

4. The apparatus of claim 1, wherein the anomaly model is trained using normal behavior of the application during peacetime.

5. The apparatus of claim 4, wherein the normal behavior of the application is based on learned characteristics of parameter values.

6. The apparatus of claim 5, wherein triggering a suspect indicator upon at least one of the parameter values exceeding its learned characteristics.

7. The apparatus of claim 5, wherein the parameter value is at least one of the group consisting of query arguments, query headers, and query body parameters.

8. The apparatus of claim 1, wherein the anomaly model detects anomalous structure within the transaction based on the training of the anomaly model.

9. The apparatus of claim 1, wherein the anomaly model employs vector embedding to evaluate a scenario comprised of a sequence of transactions that includes the transaction to determine if the source of the transaction is malicious and wherein subsequent transactions from the source of the transaction will be designated as malicious.

10. The apparatus of claim 1, wherein the anomaly model is trained using suspect indicators that are based on at least one of counters or rates with tuned threshold values.

11. The apparatus of claim 1, wherein the attack model is trained to recognize general characteristics of attacker behaviors.

12. The apparatus of claim 1, wherein the attack model is trained based on supervised learning from historic transactions.

13. The apparatus of claim 1, wherein the attack model is trained to identify malicious values in fields of the transaction.

14. The apparatus of claim 13 wherein the malicious values in fields of the transaction are strings that constitute at least one of a structured query language (SQL) injection and a code injection.

15. The apparatus of claim 1, wherein the attack model is trained to detect probing behavior.

16. The apparatus of claim 1, wherein the score is for at least the source of the transaction.

17. The apparatus of claim 16, wherein the score for the source is based on a scenario comprised of sequence of transactions from the source.

18. The apparatus of claim 1, wherein the score is at least based on the transaction itself.

19. The apparatus of claim 1, wherein the score of the transaction is based on a scenario comprised of a sequence of transactions of which the transaction is a part.

20. The apparatus of claim 1, wherein the scoring model is a trained scoring model.

21. The apparatus of claim 1, wherein the available model types further includes an attack pattern mining model.

22. The apparatus of claim 1, wherein, when the evaluator receives for the transaction a malicious determination from the evaluator, the enforcer causes an attempt to clean the transaction to take place and when cleaning of the transaction is successful, routes the cleaned transaction to the protected entity.

23. A method for filtering layer 7 transactions, each transaction being transmitted from a source to a protected entity, comprising:
receiving, at an enforcer, a layer 7 transaction destined for a protected application prior to the transaction possibly being supplied to the protected entity; and
supplying the transaction, by the enforcer, to an evaluator, wherein the evaluator includes at least a scoring model that determines a score indicative of whether the transaction is malicious or non-malicious based on input from at least one trained model, the transaction being supplied within the evaluator to each of the at least one trained model, each of the at least one trained model being a model from a set of available model types, the available model types including at least an anomaly model and an attack model; and
wherein the enforcer routes the transaction to the protected entity when the evaluator does not receive for the transaction a malicious determination from the evaluator;
wherein the enforcer operates in real-time and the evaluator operates in at least near real-time.

24. The method of claim 23, further comprising training the anomaly model using normal behavior of the application during peacetime.

25. The method of claim 23, wherein the anomaly model employs vector embedding to evaluate a scenario comprised of a sequence of transactions that includes the transaction to determine if the source of the transaction is malicious and wherein subsequent transactions from the source of the transaction will be designated as malicious.

26. The method of claim 23, further comprising training the attack model to recognize general characteristics of attacker behaviors using supervised learning from historic transactions.

27. The method of claim 23, further comprising detecting probing behavior by the attack model, wherein the attack model is trained to detect probing behavior.

28. The method of claim 23, wherein the score is for at least the source of the transaction.

29. The method of claim 28, wherein the score for the source is based on a scenario comprised of sequence of transactions from the source.

30. The method of claim 23, wherein the score is at least based on the transaction itself.

31. The method of claim 23, wherein the score of the transaction is based on a scenario comprised of sequence of transactions of which the transaction is a part.

32. The method of claim 23, wherein the available model types further include an attack pattern mining model.
